(19) United States
(12) Patent Application Publication
(10) Pub. No.: US 2024/0195928 A1
(43) Pub. Date: Jun. 13, 2024

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventor: Ayaka Shinkawa, Kanagawa (JP)

(73) Assignee: FUJIFILM Business Innovation Corp., Tokyo (JP)

(21) Appl. No.: 18/311,246

(22) Filed: May 3, 2023

(30) Foreign Application Priority Data
Dec. 12, 2022 (JP) 2022-198166

(51) Int. Cl. H04N 1/44; H04N 1/00; H04R 1/02

(52) U.S. Cl. CPC H04N 1/44; H04N 1/00015; H04N 1/00029; H04N 1/0005; H04N 1/00925; H04R 1/028

(57) ABSTRACT

An information processing apparatus includes a processor configured to prohibit, in a case where an opening/closing portion of a target apparatus that generates an operation sound is opened, recording of the operation sound by a microphone provided inside the target apparatus.

### CROSS-REFERENCE TO RELATED APPLICATIONS

This application is based on and claims priority under 35 USC 119 from Japanese Patent Application No. 2022-198166 filed Dec. 12, 2022.

### BACKGROUND

### (i) Technical Field

The present invention relates to an information processing apparatus and a non-transitory computer readable medium storing an information processing program.

### (ii) Related Art

In JP2007-079263A, in an image forming apparatus that performs image forming on a sheet, there is disclosed an image forming apparatus characterized by having a storage unit that stores an operation sound of the image forming apparatus in a normal state, a sound detection unit that detects an operation sound generated from the image forming apparatus, a specifying unit that specifies an abnormal spot of the image forming apparatus based on first sound information stored in the storage unit, second sound information detected by the sound detection unit, and operation information of the image forming apparatus.

In JP2008-290288A, in an image processing apparatus having an image forming unit that forms an image on printing paper and a conveyance unit that conveys the printing paper, there is disclosed an image processing apparatus characterized by including a sound conversion unit that converts a sound inside the image processing apparatus into an electric signal, a sound analysis unit that analyzes the electric signal converted by the sound conversion unit, and an output unit that outputs a result analyzed by the sound analysis unit.

In JP2016-111472A, there is disclosed an image forming apparatus characterized by including a voice collecting unit that collects a voice and outputs voice data, a voice recording unit that records the voice data in a voice storage unit, a data editing unit that adds the voice data to image data, and a control unit that causes the voice recording unit to perform the voice recording operation only in a case where a noise level included in the voice data collected by the voice collecting unit is equal to or lower than a predetermined limit threshold level.

In JP2017-120199A, there is disclosed a diagnosis apparatus including a recording unit that records a sound emitted by a diagnosis target, a reception unit for receiving an operation from a user, an acquisition unit that acquires recorded data of a predetermined time before and after/including a time of reception as data for diagnosis in a case where the reception unit receives an operation, and a warning unit that warns that the recording unit has started recording before reception of an operation by the reception unit.

### SUMMARY

Aspects of non-limiting embodiments of the present disclosure relate to an information processing apparatus and a non-transitory computer readable medium storing an information processing program that may prevent a sound other than an operation sound from being recorded.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to prohibit, in a case where an opening/closing portion of a target apparatus that generates an operation sound is opened, recording of the operation sound by a microphone provided inside the target apparatus.

### BRIEF DESCRIPTION OF THE DRAWINGS

Exemplary embodiment(s) of the present invention will be described in detail based on the following figures, wherein:

FIG. 1 is a side view of an image forming system;

FIG. 2 is a block diagram showing an example of a hardware configuration of an image forming apparatus and a paper feeding device;

FIG. 3 is a schematic diagram showing an example of an internal configuration of the image forming apparatus; and

FIG. 4 is a flowchart showing a flow of processing of an information processing program.

### DETAILED DESCRIPTION

Hereinafter, an exemplary embodiment of the present disclosure will be described in detail with reference to the accompanying drawings.

First, an outline of an information processing apparatus according to the present exemplary embodiment will be described.

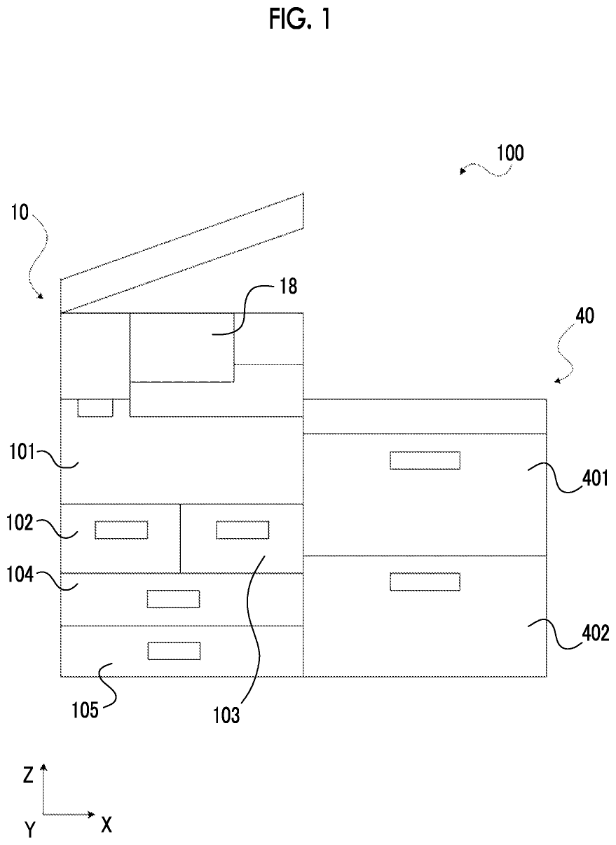

An image forming system 100 shown in FIG. 1 includes an image forming apparatus 10 and a paper feeding device 40 provided outside the image forming apparatus 10. The image forming apparatus 10 is an example of a target apparatus according to the present exemplary embodiment. The target apparatus may be realized by an apparatus other than the image forming apparatus 10. In addition, in the present exemplary embodiment, the image forming system 100 including the paper feeding device 40 that is externally attached to the image forming apparatus 10 will be described, but the image forming system 100 may be realized only by the image forming apparatus 10.

The image forming apparatus 10 according to the present exemplary embodiment receives a job assigned by a user and executes the assigned job. An example of a job executed by the image forming apparatus 10 is a printing job of forming a document image generated from a read document or the like on a recording medium such as paper.

In addition, the image forming apparatus 10 according to the present exemplary embodiment is provided with a microphone inside, and records an operation sound used for an abnormality diagnosis processing for determining whether or not an abnormality has occurred in the image forming apparatus 10. Here, an operation sound refers to, for example, a sound of a machine configuration provided inside the image forming apparatus 10 generated by the image forming apparatus 10 executing a job. An example of the machine configuration is a rotating body such as a conveyance roller that conveys paper, and a drive source such as a motor for driving the conveyance roller, but the present invention is not limited thereto. An example of an operation sound is a sound generated by the conveyance roller, the motor, and the like being operated by execution of a job of the image forming apparatus 10.

Here, even in a state where a paper feeding tray provided in the image forming apparatus 10 has been opened or in a state where a cover that is opened and closed in a case of replacing a cartridge including a container that contains a coloring material such as toner or ink (hereinafter, referred to as “front cover”) has been opened, the image forming apparatus 10 may start a job instructed by a user. In addition, even in a case where the paper feeding tray or the front cover is opened while the image forming apparatus 10 is executing a job, the image forming apparatus 10 may continuously execute the job.

In a case where an operation sound is recorded in the above case, for example, even a conversation content of people having a conversation near the image forming apparatus 10 may be included in recorded data, which may lead to leakage of confidential information.

In addition, in a case where the front cover and the paper feeding tray are opened or the front cover and the paper feeding tray in the opened state are closed during execution of a job in which recording of an operation sound is performed, an opening/closing sound is included in the recorded data, and obtaining an appropriate result in the abnormality diagnosis processing based on the recorded data is difficult. The conversation and the opening/closing sound of the front cover, the paper feeding tray, and the like are examples of sounds other than an operation sound.

Therefore, in a case where an opening/closing portion such as the front cover and the paper feeding tray has been opened, the image forming apparatus 10 according to the present exemplary embodiment prohibits the recording of an operation sound.

Hereinafter, a configuration of the image forming system 100 will be described in detail.

As shown in FIG. 1, the image forming apparatus 10 includes a front cover 101, a paper feeding tray 102, a paper feeding tray 103, a paper feeding tray 104, and a paper feeding tray 105. In addition, according to an example shown in FIG. 1, the paper feeding device 40 that is externally attached to the image forming apparatus 10 includes a paper feeding tray 401 and a paper feeding tray 402.

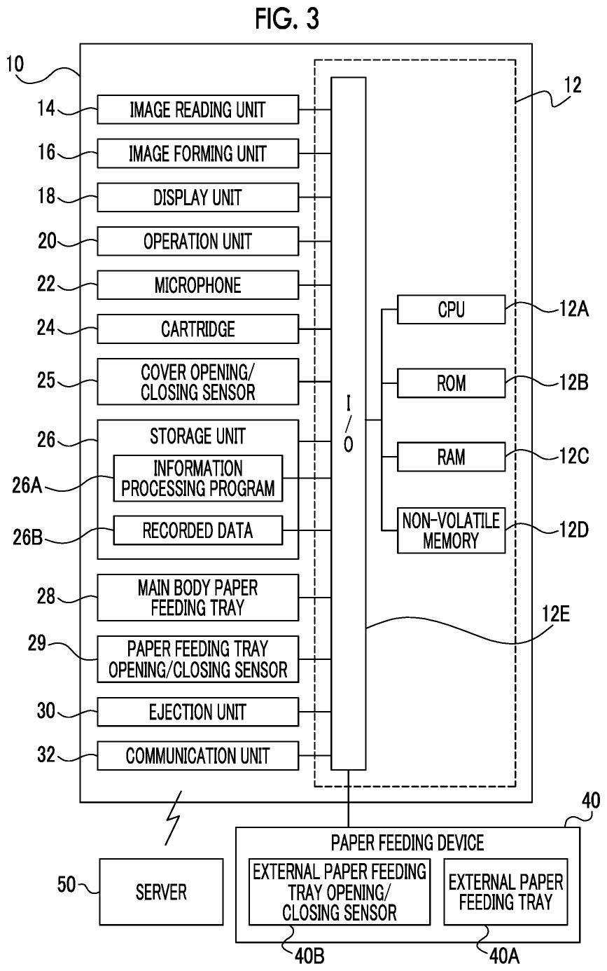

Hereinafter, in a case of collectively referring, the paper feeding trays 102 to 105 provided in the image forming apparatus 10 are referred to as a main body paper feeding tray 28. In addition, in a case of collectively referring, the paper feeding trays 401 and 402 provided in the paper feeding device 40 are referred to as an external paper feeding tray 40A (refer to FIG. 3).

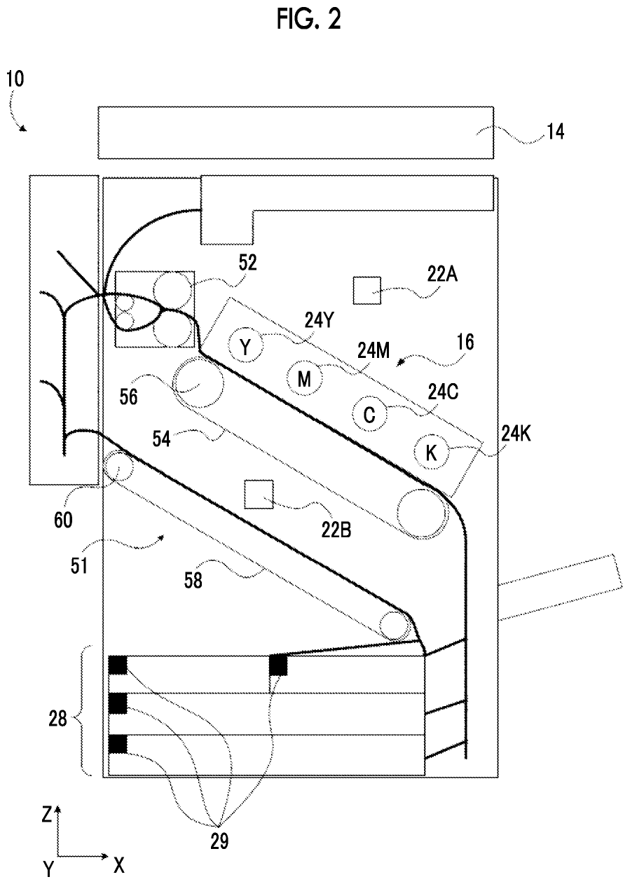

A user may open the front cover 101, and, as shown in FIG. 2, replace a yellow (Y) cartridge 24Y, a magenta (M) cartridge 24M, a cyan (C) cartridge 24C, and a black (K) cartridge 24K replaceably provided in an image forming unit 16 of the image forming apparatus 10. In a case where the cartridges 24Y, 24M, 24C, and 24K are not distinguished, the cartridges are referred to as cartridges 24. In addition, by opening the main body paper feeding tray 28 and the external paper feeding tray 40A, a user may replenish each paper feeding tray with paper.

The front cover 101, and the paper feeding tray 102 to the paper feeding tray 105 (main body paper feeding tray 28) are examples of an opening/closing portion of the target apparatus. In addition, the paper feeding trays 401 and 402 (external paper feeding tray 40A) are examples of an opening/closing portion of the paper feeding device 40.

FIG. 3 is a block diagram showing an example of a configuration of the image forming apparatus 10 and the paper feeding device 40. The image forming apparatus 10 shown in FIG. 3 includes components such as a control unit 12, an image reading unit 14, the image forming unit 16, a display unit 18, an operation unit 20, a microphone 22, a cartridge 24, a cover opening/closing sensor 25, a storage unit 26, the main body paper feeding tray 28, a paper feeding tray opening/closing sensor 29, an ejection unit 30, and a communication unit 32. The control unit 12 is an example of the information processing apparatus.

The control unit 12 controls each component connected to the control unit 12. The control unit 12 includes a central processing unit (CPU) 12A, a read only memory (ROM) 12B, a random access memory (RAM) 12C, a non-volatile memory 12D, and an input/output interface (I/O) section 12E.

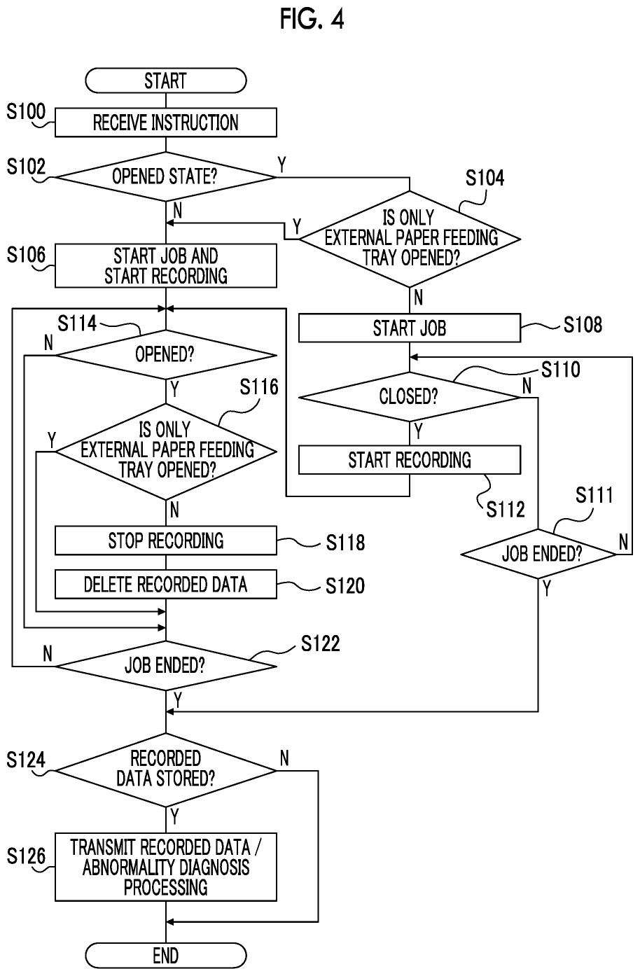

The CPU 12A is a central arithmetic processing unit, and reads an information processing program 26A from the storage unit 26 and executes the information processing program 26A. Details of the information processing program 26A will be described later (refer to FIG. 4). The CPU 12A controls the image forming apparatus 10 and the like by executing the read program with the RAM 12C as a work area. The CPU 12A is an example of a processor.

The CPU 12A, the ROM 12B, the RAM 12C, and the non-volatile memory 12D are connected to the I/O section 12E via a bus so as to be communicable with each other.

The image reading unit 14 includes, for example, a charge-coupled device (CCD) image sensor or the like that reads a document set in the image forming apparatus 10 and generates a document image.

The image forming unit 16 forms the document image generated by the image reading unit 14 on a recording medium such as paper by using, for example, an electrophotographic method or an inkjet recording method. In a case where the electrophotographic method is adopted, the cartridge 24 is a toner cartridge including a container that contains toner as an example of a coloring material. In addition, in a case where the inkjet recording method is adopted, the cartridge 24 is an ink cartridge including a container that contains ink as an example of a coloring material. In the present exemplary embodiment, a case where the image forming unit 16 forms an image on a recording medium by the electrophotographic method will be described.

The display unit 18 is configured by combining, for example, a touch panel with a liquid crystal display, an organic EL display, or the like. On the display unit 18, an image, a pop-up image, or the like corresponding to a user's touch operation, processing of the image forming apparatus 10, and the like is displayed.

The operation unit 20 is an operation key, an operation button, a power button, and the like provided in the image forming apparatus 10.

A user may assign a job to the image forming apparatus 10 or instruct start of a job by the touch operation on the display unit 18, pressing down an operation button to the operation unit 20, or the like.

The microphone 22 is installed inside the image forming apparatus 10, and collects an operation sound generated by the image forming unit 16 or the like. The microphone 22 is disposed at a place where an operation sound generated by the image forming unit 16 or the like can be collected. Details such as the disposition of the microphone 22 will be described later. In addition, the collected operation sound is stored as recorded data 26B in the storage unit 26 at any time.

As shown in FIG. 2, the cartridge 24 includes, for example, cartridges 24Y, 24M, 24C, and 24K of a coloring material such as yellow (Y), magenta (M), cyan (C), and black (K). The user can replenish an insufficient coloring material by replacing each cartridge. In FIG. 2, a photoconductor, a charger, a developer, a transfer roller, and the like are not shown for the sake of brevity of description.

The cover opening/closing sensor 25 detects an opened/closed state of the front cover 101.

The storage unit 26 is configured of, for example, a solid state drive (SSD) or a hard disk drive (HDD). The storage unit 26 stores, for example, the information processing program 26A and various programs. In addition, the storage unit 26 stores, for example, the recorded data 26B.

The recorded data 26B is data obtained by recording an operation sound generated from the image forming unit 16 or the like by execution of a job.

The paper feeding tray opening/closing sensor 29 is provided, for example, one by one for each of the paper feeding tray 102, the paper feeding tray 103, the paper feeding tray 104, and the paper feeding tray 105. Each paper feeding tray opening/closing sensor 29 detects an opened/closed state of the corresponding paper feeding tray among the paper feeding trays 102 to 105.

In the ejection unit 30, for example, printed matter that is ejected at an end of printing job is accumulated.

The communication unit 32 is, for example, an interface for communicably connecting a server 50 provided outside the image forming apparatus 10 and the image forming apparatus 10. For the communication unit 32, for example, communication standards such as Wi-Fi (registered trademark), Bluetooth (registered trademark), and local area network (LAN) are used.

The server 50 executes the abnormality diagnosis processing by using, for example, the recorded data 26B. An example of the server 50 is a personal computer (PC). The abnormality diagnosis processing may be configured to be executed by the image forming apparatus 10. In a case where the image forming apparatus 10 executes the abnormality diagnosis processing, for example, an abnormality diagnosis processing program is stored in advance in the storage unit 26 or the like.

The paper feeding device 40 includes an external paper feeding tray opening/closing sensor 40B in addition to the external paper feeding tray 40A described above. The external paper feeding tray opening/closing sensor 40B is provided, for example, one by one for each of the paper feeding tray 401 and the paper feeding tray 402. Each external paper feeding tray opening/closing sensor 40B detects an opened/closed state of each of the paper feeding tray 401 and the paper feeding tray 402.

The image reading unit 14, the image forming unit 16, the display unit 18, the operation unit 20, the microphone 22, the cartridge 24, the cover opening/closing sensor 25, the storage unit 26, the main body paper feeding tray 28, the paper feeding tray opening/closing sensor 29, the ejection unit 30, the communication unit 32, the paper feeding device 40, and the like are connected to the control unit 12 so as to be able to communicate with each other.

Hereinafter, information indicating the opened/closed state of the front cover 101 detected by the cover opening/closing sensor 25 will be referred to as cover opening/closing information. In addition, information indicating the opened/closed state of the paper feeding trays 102 to 105 detected by the paper feeding tray opening/closing sensor 29 is referred to as paper feeding tray opening/closing information. In addition, information indicating the opened/closed state of the paper feeding trays 401 and 402 detected by the external paper feeding tray opening/closing sensor 40B is referred to as external paper feeding tray opening/closing information. In addition, in a case of collectively referring, these pieces of information are referred to as opening/closing information.

In the opening/closing information, the opening/closing state of each of the front cover 101, the paper feeding trays 102 to 105, and the paper feeding trays 401 and 402 is respectively represented by a value such as “0” and “1”. The opening/closing information is updated according to a change in the opening/closing state of each of the front cover 101, the paper feeding trays 102 to 105, and the paper feeding trays 401 and 402. For example, assuming that the cover opening/closing information in a state where the front cover 101 has been opened is “1”, the cover opening/closing information is updated to “0” in a case where the front cover 101 has been closed.

Next, the disposition of the microphone 22 will be described with reference to FIG. 2.

FIG. 2 is a schematic diagram showing an example of an internal configuration of the image forming apparatus 10.

According to the example shown in FIG. 2, a microphone 22A is disposed in the vicinity of the image forming unit 16, and the microphone 22B is disposed in the vicinity of a conveyance unit 51. The microphone 22A collects, for example, an operation sound generated by a rotating body that constitutes the image forming unit 16 such as a photoconductor drum, a developing roller, the transfer roller (not shown), and a fixing roller 52 of a fixing unit, and by a motor for driving these rotating bodies. In addition, the microphone 22B collects an operation sound derived from a rotating body such as a drive roller 56 that drives an intermediate transfer belt 54 and a drive roller 60 that drives a conveyance belt 58 that conveys paper, and by a motor or the like that drives these rotating bodies.

Although the number of microphones 22 is set to two in an example shown in FIG. 4, the number of the microphones 22 is not limited to two, and the number of the microphone 22 may be one, or three or more microphones 22 may be installed. In addition, an installation place is not limited to the example shown in FIG. 4, and any place may be used as long as an operation sound used for an abnormality diagnosis can be collected.

The microphone 22 including the microphone 22A and the microphone 22B shown in FIG. 3 is an example of a microphone provided inside the target apparatus.

Next, an operation of the image forming apparatus 10 by the information processing program 26A will be described.

FIG. 4 is a flowchart showing a flow of processing of the information processing program 26A. The information processing program 26A is executed by the CPU 12A.

In step S100, the CPU 12A receives an instruction to execute a job from a user.

In step S102, the CPU 12A determines whether or not at least one of the front cover 101, the main body paper feeding tray 28, or the external paper feeding tray 40A is in the opened state, based on the opening/closing information. For example, in a case where at least a piece of opening/closing information among the cover opening/closing information, the paper feeding tray opening/closing information, or the external paper feeding tray opening/closing information indicates the opened state, it is determined that at least one of the front cover 101, the main body paper feeding tray 28, or the external paper feeding tray 40A is in the opened state.

In a case where at least one of the front cover 101, the main body paper feeding tray 28, or the external paper feeding tray 40A is in the opened state, the processing proceeds to processing of step S104. In a case where none of the front cover 101, the main body paper feeding tray 28, or the external paper feeding tray 40A is in the opened state, in other words, in a case where all of the front cover 101, the main body paper feeding tray 28, and the external paper feeding tray 40A have been closed, the processing proceeds to processing of step S106.

In step S104, the CPU 12A determines whether or not only the external paper feeding tray 40A is in the opened state, based on the opening/closing information. Specifically, the CPU 12A determines whether or not the external paper feeding tray opening/closing information indicates the opened state, and the cover opening/closing information and the paper feeding tray opening/closing information indicate the closed state.

In a case where it is determined that only the external paper feeding tray 40A is in the opened state, the processing proceeds to the processing of step S106. In other words, in a case where only the external paper feeding tray 40A among the front cover 101, the main body paper feeding tray 28, and the external paper feeding tray 40A is in the opened state, the processing proceeds to the processing of step S106. On the other hand, in a case where at least one of the cover opening/closing information or the paper feeding tray opening/closing information indicates the opened state, that is, in a case where at least one of the front cover 101 or the main body paper feeding tray 28 is in the opened state, the processing proceeds to processing of step S108.

In step S106, the CPU 12A starts the job assigned by the user, and also starts collecting and recording an operation sound by the microphone 22.

In step S108, the CPU 12A starts the job assigned by the user.

In step S110, the CPU 12A determines whether or not at least one of the front cover 101 or the main body paper feeding tray 28 in the opened state is closed and all of the front cover 101 and the main body paper feeding tray 28 are in the closed state.

In a case where it is determined that all of the front cover 101 and the main body paper feeding tray 28 are in the closed state, the processing proceeds to processing of step S112. In a case where at least one of the front cover 101 or the main body paper feeding tray 28 is in the opened state, the processing proceeds to processing of step S111.

In step S111, the CPU 12A determines whether or not the job has ended. In a case where the job has ended, the processing proceeds to processing of step S124, and in a case where the job has not ended, the process returns to step S110.

In step S112, the CPU 12A starts the collecting and the recording an operation sound by the microphone 22.

In step S114, the CPU 12A determines whether or not at least one of the front cover 101, the main body paper feeding tray 28, or the external paper feeding tray 40A has been opened, based on the opening/closing information.

In a case where it is determined that at least one of the front cover 101, the main body paper feeding tray 28, or the external paper feeding tray 40A has been opened, the processing proceeds to processing of step S116. In a case where none of the front cover 101, the main body paper feeding tray 28, or the external paper feeding tray 40A has been opened, the processing proceeds to processing of step S122.

In step S116, the CPU 12A determines whether or not only the external paper feeding tray 40A among the front cover 101, the main body paper feeding tray 28, and the external paper feeding tray 40A has been opened. Specifically, it is determined whether or not only the external paper feeding tray opening/closing information indicates the opened state. In a case where only the external paper feeding tray opening/closing information indicates the opened state, that is, in a case where only the external paper feeding tray 40A has been opened, the processing proceeds to the processing of step S122. On the other hand, in a case where at least one of the cover opening/closing information or the paper feeding tray opening/closing information indicates an opened state, that is, in a case where at least one of the front cover 101 or the main body paper feeding tray 28 has been opened, the processing proceeds to processing of step S118. In step S118, the CPU 12A stops the collecting and the recording an operation sound by the microphone 22.

In step S120, the CPU 12A deletes the recorded data 26B stored from a time when the recording has been started in step S106 until the recording has been stopped in step S118.

In step S122, the CPU 12A determines whether or not the job has ended. In a case where the job has ended, the processing proceeds to the processing of step S124, and in a case where the job has not ended, the process returns to step S114.

In step S124, the CPU 12A determines whether or not the recorded data 26B of the job assigned by the user is stored in the storage unit 26. In a case where the processing of step S120 is not executed and the recorded data 26B is stored in the storage unit 26, the processing proceeds to processing of step S126. In a case where the recorded data 26B has been deleted by execution of the processing of step S120 and is not stored in the storage unit 26, the processing by the information processing program 26A ends.

In step S126, in a case where the image forming apparatus 10 performs the abnormality diagnosis processing, the CPU 12A executes the abnormality diagnosis processing by using the recorded data 26B. On the other hand, in step S126, in a case where the server 50 performs the abnormality diagnosis processing, the CPU 12A transmits the recorded data 26B to the server 50.

The abnormality diagnosis processing is performed, for example, by using an analysis result obtained by performing frequency analysis on the recorded data 26B, or by using a learning model machine-trained using the recorded data 26B and an analysis result of the recorded data.

In a case where the processing of step S126 is executed, the processing by the information processing program 26A ends.

According to the present exemplary embodiment, in the processing of step S104 and step S116, in a case where it is determined that at least one of the front cover 101 or the main body paper feeding tray 28 has been opened, the image forming apparatus 10 doesn't start the recording or stops the recording. In other words, the image forming apparatus 10 of the present exemplary embodiment prohibits the recording in a case where at least one of the front cover 101 or the main body paper feeding tray 28 has been opened.

In addition, in the processing of step S104 and step S116, in a case where it is determined that all of the front cover 101 and the main body paper feeding tray 28 have been closed, the image forming apparatus 10 starts the recording. In other words, the image forming apparatus 10 of the present exemplary embodiment allows the recording in a case where all of the front cover 101 and the main body paper feeding tray 28 have been closed at a start of a job. In addition, in the image forming apparatus 10 of the present exemplary embodiment, in a case where all of the front cover 101 and the main body paper feeding tray 28, which were in the opened state at the start of the job, are in the closed state after the start of the job, the recording is allowed at a timing when all of the front cover 101 and the main body paper feeding tray 28 are closed.

In addition, according to the present exemplary embodiment, in the processing of step S114, step S116, step S118, and step S120, in a case where at least one of the front cover 101 or the main body paper feeding tray 28 is opened after the recording of an operation sound is started, the recorded data 26B is deleted.

In addition, according to the present exemplary embodiment, in the processing of step S102, step S104, step S114, and step S116, in a case where the external paper feeding tray 40A is in the opened state, since the recorded data 26B is not affected, the recording of an operation sound is started or the recording of an operation sound is not stopped. In other words, in a case where only the external paper feeding tray 40A of the paper feeding device 40 is in the opened state, the image forming apparatus 10 allows the recording of an operation sound.

According to the present exemplary embodiment described above, an abnormality or the like due to deterioration over time of the machine configuration provided in the image forming apparatus 10 such as the image forming unit 16 may be detected by using the recorded data 26B of an operation sound during a job.

In addition, according to the present exemplary embodiment, in a situation where an opening/closing sound of the front cover 101 and the main body paper feeding tray 28 provided in the image forming apparatus 10 is included in the recorded data 26B, the recorded data 26B is deleted. Therefore, the abnormality diagnosis processing may be executed by using the recorded data 26B that does not include the opening/closing sound, and the abnormality may be appropriately detected.

In addition, according to the present exemplary embodiment, in a state where the front cover 101 and the main body paper feeding tray 28 have been opened, which is a situation where the microphone 22 easily collects the conversations between people, the recording is not started or the recording is stopped, and in a case where the recording is stopped, the recorded data 26B is deleted. Therefore, the recorded data 26B that may include the conversation is deleted. Therefore, since the abnormality diagnosis processing may be executed by using the recorded data 26B that does not include the conversation, the abnormality may be appropriately detected and the leakage of the confidential information may be prevented.

In addition, an opening/closing sound of the external paper feeding tray 40A of the paper feeding device 40 provided outside the image forming apparatus 10 does not affect the collecting of an operation sound by the microphone 22. According to the present exemplary embodiment, since an opened/closed state of the external paper feeding tray 40A does not affect a start and a stop of the recording and deletion of the recorded data 26B, an operation sound may be recorded regardless of opening/closing of the external paper feeding tray 40A during a job.

Although the exemplary embodiment has been described above, the technical scope of the present disclosure is not limited to the scope described in the above exemplary embodiment. Various modifications or improvements can be made to the exemplary embodiment without departing from the gist of the invention, and the modified or improved form is also included in the technical scope of the present disclosure.

In addition, the above exemplary embodiment does not limit the disclosure according to the claims, and not all combinations of features described in the exemplary embodiment are needed for the solution of the invention. Various inventions are included in the exemplary embodiment described above, and various inventions are extracted by combining plural disclosed constituent elements. Even in a case where some constituent elements are deleted from all the constituent elements shown in the exemplary embodiment, as long as an effect is obtained, a configuration in which some constituent elements are deleted can be extracted as an invention.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the present exemplary embodiment, a form in which the information processing program 26A is installed in the storage unit 26 has been described, but the present invention is not limited thereto. The information processing program 26A according to the present exemplary embodiment may be provided in a form of being recorded on a computer-readable storage medium. For example, the information processing program 26A according to the present exemplary embodiment may be provided in a form of being recorded on an optical disk such as a compact disc (CD)-ROM and a digital versatile disc (DVD)-ROM, or on a semiconductor memory such as a universal serial bus (USB) memory and a memory card. In addition, the information processing program 26A according to the present exemplary embodiment may be acquired from an external device via the communication unit 32.

In addition, in the exemplary embodiment described above, a case where the processing in the image forming apparatus 10 is realized by a software configuration by using a computer by executing a program is described, but the present invention is not limited thereto. For example, information processing may be realized by a hardware configuration or a combination of a hardware configuration and a software configuration.

Further, needless to say, the configuration of the image forming apparatus 10 described in the exemplary embodiment described above is an example, and an unnecessary part may be deleted or a new part may be added without departing from the gist of the present disclosure.

In addition, needless to say, the flow of the processing of the information processing program 26A described in the above exemplary embodiment (refer to FIG. 4) is also an example, and an unnecessary step may be deleted, a new step may be added, or processing order may be changed without departing from the gist of the present disclosure.

The following will be further disclosed regarding the above exemplary embodiment.

(((1)))

An information processing apparatus, comprising:
a processor configured to:
   prohibit, in a case where an opening/closing portion of a target apparatus that generates an operation sound is opened, recording of the operation sound by a microphone provided inside the target apparatus.
      (((2)))

The information processing apparatus according to (((1))), wherein the processor is configured to:
permit, in a case where the opening/closing portion is closed, the recording of the operation sound.
   (((3)))

The information processing apparatus according to (((2))), wherein the processor is configured to:
delete, in a case where the opening/closing portion is opened after the recording of the operation sound is started, the operation sound that has been recorded.
   (((4)))

The information processing apparatus according to (((1))) to (((3))),
wherein the target apparatus is an image forming apparatus that forms an image on a recording medium.
   (((5)))

The information processing apparatus according to (((4))),
wherein the opening/closing portion includes at least one of a tray that contains the recording medium or a cover that is opened and closed in a case of replacing a cartridge including a container that contains a coloring material.
   (((6)))

The information processing apparatus according to (((4))) or (((5))), wherein the processor is configured to:
permit, in a case where an opening/closing portion of a paper feeding device that is externally attached to the image forming apparatus is opened, the recording of the operation sound.
   (((7)))

A non-transitory computer readable medium storing an information processing program causing a computer to execute processing, the processing comprising:
prohibiting, in a case where an opening/closing portion of a target apparatus that generates an operation sound is opened, recording of the operation sound by a microphone provided inside the target apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
prohibit, in a case where an opening/closing portion of a target apparatus that generates an operation sound is opened, recording of the operation sound by a microphone provided inside the target apparatus.

2. The information processing apparatus according to claim 1, wherein the processor is configured to:
permit, in a case where the opening/closing portion is closed, the recording of the operation sound.

3. The information processing apparatus according to claim 2, wherein the processor is configured to:
delete, in a case where the opening/closing portion is opened after the recording of the operation sound is started, the operation sound that has been recorded.

4. The information processing apparatus according to claim 1,
wherein the target apparatus is an image forming apparatus that forms an image on a recording medium.

5. The information processing apparatus according to claim 4,
wherein the opening/closing portion includes at least one of a tray that contains the recording medium or a cover that is opened and closed in a case of replacing a cartridge including a container that contains a coloring material.

6. The information processing apparatus according to claim 4, wherein the processor is configured to:
permit, in a case where an opening/closing portion of a paper feeding device that is externally attached to the image forming apparatus is opened, the recording of the operation sound.

7. The information processing apparatus according to claim 5, wherein the processor is configured to:
permit, in a case where an opening/closing portion of a paper feeding device that is externally attached to the image forming apparatus is opened, the recording of the operation sound.

8. A non-transitory computer readable medium storing an information processing program causing a computer to execute processing, the processing comprising:
prohibiting, in a case where an opening/closing portion of a target apparatus that generates an operation sound is opened, recording of the operation sound by a microphone provided inside the target apparatus.

9. An information processing apparatus comprising:
prohibiting means for prohibiting, in a case where an opening/closing portion of a target apparatus that generates an operation sound is opened, recording of the operation sound by a microphone provided inside the target apparatus.
